(19) United States
(12) Patent Application Publication
(10) Pub. No.: US 2018/0351285 A1
(43) Pub. Date: Dec. 6, 2018

(54) ELECTRICAL CONNECTION ASSEMBLY FOR SUBSEA APPLICATIONS

(71) Applicant: Nuovo Pignone Tecnologie Srl, Florence (IT)

(72) Inventors: Manuele BIGI, Florence (IT); Massimiliano ORTIZ NERI, Florence (IT); Matteo DOZZINI, Florence (IT); Iacopo DEL CORONA, Florence (IT); Alberto MILANI, Florence (IT)

(21) Appl. No.: 15/780,073

(22) PCT Filed: Nov. 28, 2016
(86) PCT No.: PCT/EP2016/078983

§ 371 Date: May 30, 2018

(30) Foreign Application Priority Data
Nov. 30, 2015 (IT) 102015000078319

(51) Int. Cl. H01R 13/523; H01R 13/52; H01R 39/32; H02G 3/04; H02G 9/00

(52) U.S. Cl. CPC H01R 13/523; H01R 13/521; H02K 5/132; H02G 3/0462; H02G 9/00; H01R 39/32

(57) ABSTRACT

An electrical connection assembly for subsea applications includes an electrical conductor cable electrically connectable to a winding of an electrical load and electrically connectable to an electrical power source; a first insulating element configured to be placed over the winding; a second insulating element placed over the electrical conductor cable; the first insulating element partially overlaps the second insulating element, the first insulating element is sealed onto the second insulating element.

### BACKGROUND OF THE INVENTION

The subject matter of the present disclosure relates to an electrical connection assembly for subsea applications. As an example of such connection assembly, but without any limitation intended, the following disclosure will describe the connection between an electric motor of a subsea machine and an external plug for a power cable intended to provide electric power to such machine. Such subsea machine can be a subsea compressor, such as those designed for application in the oil and gas technical field.

### BRIEF DESCRIPTION OF THE INVENTION

In the current state of the art, an electrical connection assembly for subsea applications comprises a high power electrical conductor, which is connected to the winding of a stator of an electric motor on a first end. On a second end, the electrical conductor is connected to an electrical penetrator, which is designed to be coupled to an external cable in order to be connected to an external power source.

In order to provide electrical insulation, as well as protection from the subsea aggressive environment, the electrical conductor is enveloped in an insulating sleeve. Such insulating sleeve is, for example, composed of a three layer structure. An inner layer is made of mica, an outer layer is made of glass fiber and an intermediate layer is made of kevlar. The insulating sleeve is impregnated with thermosetting resin, thus guaranteeing a fluid tight between the electrical conductor, the winding and the penetrator.

### SUMMARY

Disadvantageously, in such electrical connection assembly, the insulating layer is sealed directly onto the penetrator. Since the insulating layer is impregnated with thermosetting resin, its disassembly is inherently impossible. Thus, should it be necessary for any reason to replace the penetrator, the entire connection assembly has to be destroyed and remade.

A first embodiment of the invention therefore relates to an electrical connection assembly for subsea applications. The assembly comprises an electrical conductor cable electrically connectable to a winding of an electrical load. The cable is also electrically connectable to an electrical power source.

The assembly comprises a first insulating element configured to be placed at least in part over the winding. A second insulating element is placed at least in part over the electrical conductor cable. The first insulating element partially overlaps the second insulating element. Also, the first insulating element is sealed onto the second insulating element.

Furthermore, the second insulating element comprises a covering pipe separated from said cable by means of an insulating sleeve so to define a hermetically sealed space between the covering pipe and the conductor cable.

In an embodiment, this electrical connection assembly is provided with both a first and a second insulating element. The first insulating element can be impregnated with thermosetting resin, as previously described, while the second insulating element can be removably coupled to the penetrator. In this way, the penetrator can be replaced without destroying the connection.

### BRIEF DESCRIPTION OF THE DRAWINGS

Further details and specific embodiments will refer to the attached drawings, in which:

FIG. 1 is a schematic representation of an electrical connection assembly for subsea applications;

FIG. 2 is a detail of the electrical connection assembly of FIG. 1;

FIG. 3 is a schematic representation of an electrical connection assembly for subsea applications;

FIGS. 4A, 4B, 4C, 4D and 4E are schematic representations of respective phases of the assembly procedure of the electrical connection assembly of FIGS. 1 and 2; and

FIGS. 5A and 5B show a further detail of the electrical connection assembly of FIG. 1.

### DETAILED DESCRIPTION

The following description of exemplary embodiments refer to the accompanying drawings. The same reference numbers in different drawings identify the same or similar elements. The following detailed description does not limit the invention. Instead, the scope of the invention is defined by the appended claims.

Reference throughout the specification to “one embodiment” or “an embodiment” means that a particular feature, structure, or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

With reference to the attached drawings, with the number 1 is indicated an electrical connection assembly for subsea applications. The assembly 1 is connectable to a winding 2 of an electrical load (not shown). In particular, the electrical load may be an electric motor configured to be operated underwater and, as such, the winding 2 is not part of the assembly 1. The winding 2 and the electric load are not considered as part of embodiments of the present invention.

The electric motor is configured to operate underwater, in particular on the sea bottom. The electric motor is cooled by means of a fluid, generally a gas, processed by another machine, generally a compressor, directly/indirectly driven by the electric motor. Said fluid can be sour, acid and under pressure, usually above 15 bar.

Said assembly 1 is positioned inside the casing containing the electric motor and it's provided for electrically connecting an electric power source to the electric motor.

Being the assembly 1 inside the casing of the electric motor, the assembly 1 is wetted by said cooling fluid.

This fluid surrounds the assembly 1 and consequently the latter needs to be protected both mechanically (against pressure) and chemically (against sour and acid)

The assembly 1 comprises an electric conductor cable 4, which is designed to be connected to the winding 2, in particular to a terminal part of the winding 2 coming out from a coil of the winding 2 itself. Also, the second conductor 4 is electrically connectable to an external electrical power source (not shown), in order to supply power to the electric load through the winding 2.

With more detail, a first end 4a of the cable 4 is connectable to the winding 2. Indeed, the assembly 1 comprises a pin 17, which is joined onto the first end 4a of the cable 4. In an embodiment, the pin 17 is crimped to the cable 4 with a further crimping sleeve 23.

Furthermore, the pin 17 itself can be crimped with a crimping sleeve 10 onto the winding 2. Indeed, the crimping sleeve 10 forms part of the electrical connection between the winding 2 and the cable 4. Alternatively, the cable 4 can be connected directly to the winding 2 by means of the sleeve 10 and without the pin 17.

Both solutions allow to create an electric stable electrical connection between winding 2 and cable 4.

A second end 4b of the cable 4 is connectable to the electrical power source 5. With additional detail, the electrical connection assembly 1 also comprises an electric terminal 8, which is attachable to an external side of a casing 9 containing the electrical load and the assembly 1. The electric terminal 8 is also electrically connectable to the electrical power source 5. Moreover, a portion of the electric terminal 8 faces the sea ambient.

The cable 4 is electrically connected to the electric terminal 8. Indeed, the electric terminal 8 is called a “penetrator” in the technical field, and is designed to couple with a purpose built plug (not shown in the drawings). A further pin 18 is crimped onto the second end 4b of the cable 4. The further pin 18 is configured to be connected like a plug with the electric terminal 8, which is configured as a socket for said plug.

No further details will be given regarding the electric conductor cable 4 itself, as it is considered known to the person skilled in the art.

For insulating the components described above from an aggressive process fluid which is under pressure, the electrical connection assembly 1 also comprises a first insulating element 6. Such first insulating element 6 is placed over the terminal part of the winding 2 of the electrical load 3. Also, the first insulating element 6 is placed over at least a portion of the electrical conductor cable 4.

Indeed, in the example shown in the figures, the first insulating element 6 comprises a multilayer sheath 19. In such sheath 19, a first layer 19, closest to the cable 4 and in contact with the winding 2, is made of mica. A second layer 19b, placed directly over the first layer 19a is made of kevlar. A third layer 19c, placed directly onto the second layer 19b, is made from glass fiber.

The multilayer sheath 19 is impregnated with a thermosetting resin, so that the layers 19a, 19b and 19c are firmly fixed to one another.

The multilayer sheath 19 is also firmly attached on the winding 2 and on a second insulating element 7 arranged on the cable 4.

The multilayer sheath 19 arranged over the winding 2 and the cable 4 allows to insulate these elements from the sour and under pressure external ambient.

A second insulating element 7 is placed over the cable 4. Specifically, the second insulating element 7 is joined to the cable 4 near the first end 4a. Indeed, the second insulating element 7 is tasked with providing insulation to most of the cable 4.

With more detail, the second insulating element 7 comprises insulating sleeve 11, which is, in an embodiment, placed near the first end 4a of the cable 4. The sleeve 11 has in particular the shape of a hollow cylinder, in which the cable 4 is inserted.

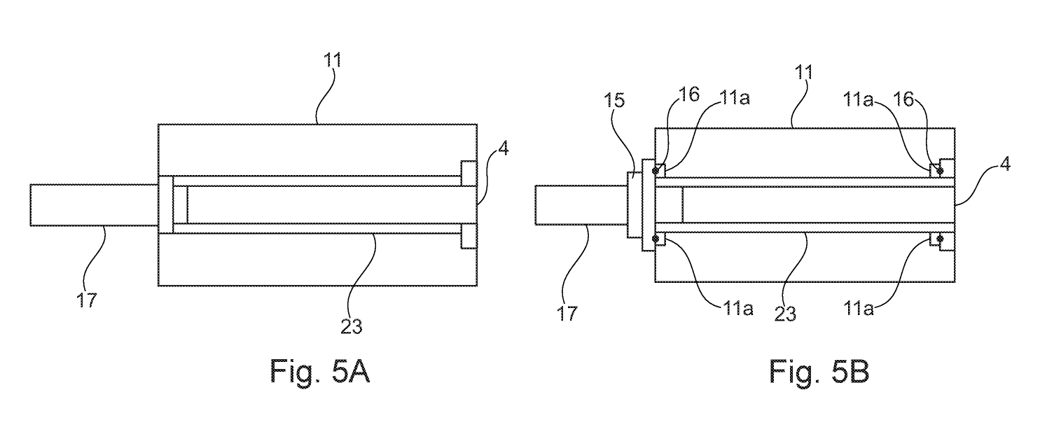

According to other embodiments of the invention, the sleeve 11 is made from ceramic. The cable 4 and the sleeve 11 are therefore joined by ceramic brazing, as shown for example in FIG. 5a. With more detail, the further crimping sleeve 23, when present, is the part of the cable 4 which is attached to the sleeve 11. In an alternative embodiment, the cable 4 and the sleeve 11 may be joined by gluing. In a further alternative embodiment, shown in FIG. 5b, a mechanical connection, itself comprising a nut 15 and seals 16 can be made between the cable 4 and the sleeve 11. With more detail, the seals 16 are placed in respective recesses 11a placed on the opposite ends of the sleeve 11. These seals 16 act between the further crimping sleeve 23 and the sleeve 11. The nut 15 is placed on the end of the sleeve 11 on the same side of the pin 17.

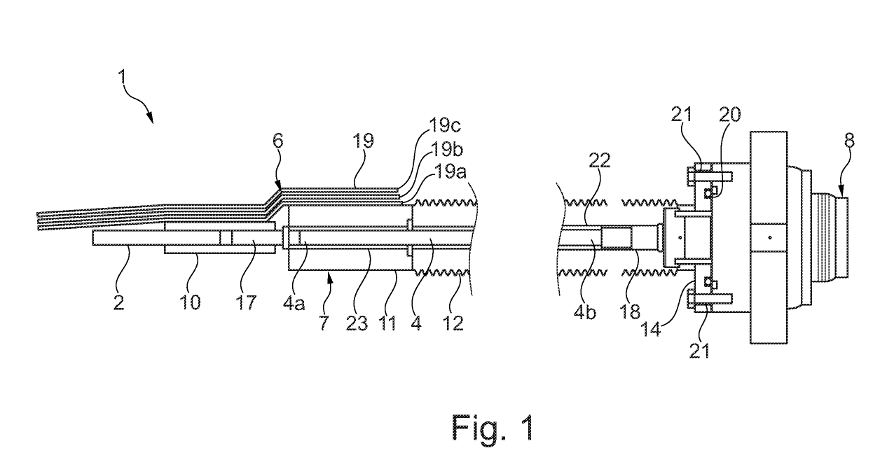

As shown in FIGS. 1-3, the first insulating element 6 is attached onto the insulating sleeve 11.

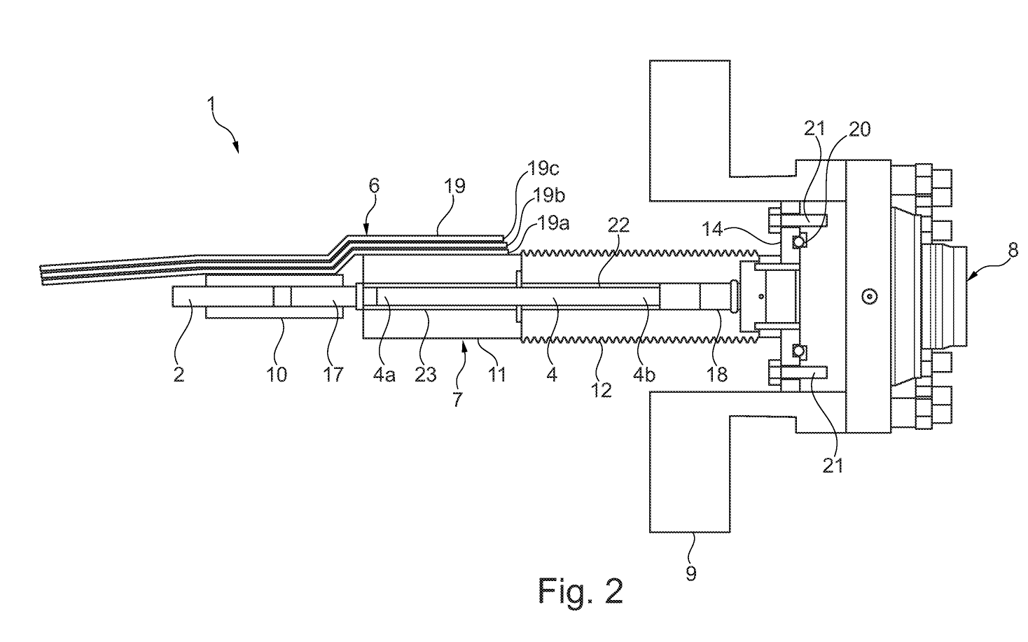

Additionally, as shown in FIGS. 1 and 2, the second insulating element 7 can comprise a covering pipe, specifically a flexible pipe 12 attached to the insulating sleeve 11. The covering pipe can be the flexible pipe 12 or a rigid tube 13. Preferably, the flexible pipe 12 surrounds the insulating sleeve 11 in order to separate it from the cable 4. Said insulating sleeve 11 and flexible pipe 12 are, in an embodiment, brazed together. The flexible pipe 12 surround the portion near to the second end 4b of the cable 4, so to create a space between them. This space inside the flexible pipe 12 is hermetically sealed and can be filled with oil, in order to improve insulation of the cable 4 and avoid implosion due to differential pressure across the external and internal sides of flexible pipe 12. Alternatively, said space can be filled with an inert gas under pressure.

The flexible pipe 12 allows to facilitate the connection of the cable 4 to the electric terminal 8.

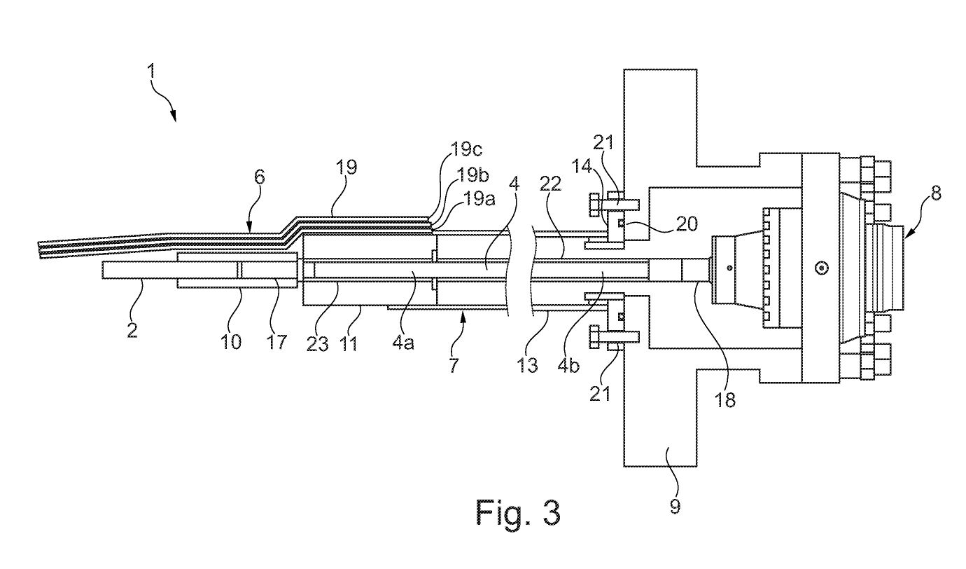

Alternatively, as shown in FIG. 3, the covering pipe is a rigid tube 13 attached to the insulating sleeve 11.

Regardless, the portion of the cable 4 inside either the flexible pipe 12 or the rigid tube 13 is protected by a silicon sheath 22, which is directly in contact with the cable 4.

The covering pipe is, in an embodiment, made of a material not-permeable to gasses, more particularly, to natural gasses containing CO2, HS2 or chlorides. In an embodiment said covering pipe is made of metal.

According to the embodiments described, the first insulating element 6 partially overlaps the second insulating element 7. The first insulating element 6 is in particular sealed onto the second insulating element 7.

Also, in an embodiment of the invention shown in FIGS. 1 and 2, the second insulating element 7 is connectable to a casing 9 of a subsea device containing the assembly 1, either directly or indirectly.

As shown in FIGS. 1 and 2, the second insulating element 7 can be directly attached onto the electric terminal 8. In particular, the second insulating element 7 is sealed onto the electric terminal 8.

With additional detail, the second insulating element 7 comprises a flange 14. In a first embodiment, shown in FIGS. 1 and 2, the flange 14 is sealed onto the electric terminal 8. In an alternative embodiment, shown in FIG. 3, the flange 14 is sealed onto the above mentioned casing 9.

In both embodiments, the flange 14 is attached by fastening means 21, for example screws, to respectively the electric terminal 8 or the casing 9. The seal on the flange 14 is ensured by the presence of a seal ring 20. Depending on the specific embodiment of the invention, the flange 14 is physically connected and sealed either onto the flexible pipe 12 or onto the rigid tube 13. In particular, said flange 14 is connected to the free end of the flexible pipe 12 or rigid tube 13. The free end being that opposite to the end connected to the insulating sleeve 11.

When the flexible pipe 12 or rigid tube 13 is sealed to the electric terminal 8 or the casing 9, the space within the flexible pipe 12 or rigid tube 13 is hermetically sealed within respect to the ambient soaked by the process fluid.

According to the present solution the cable 4 is continuously isolated from the sour and under pressure environment create by the process fluid surrounding the assembly.

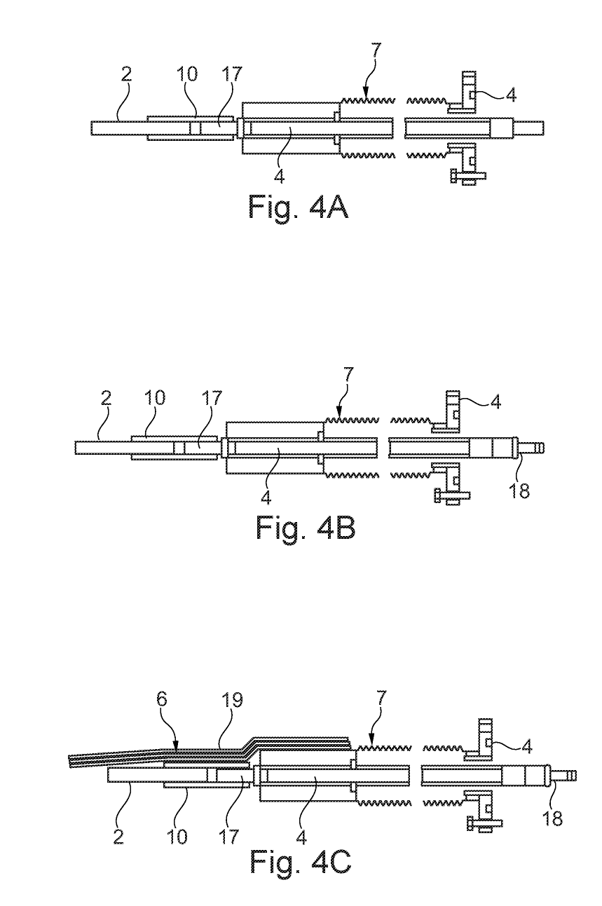

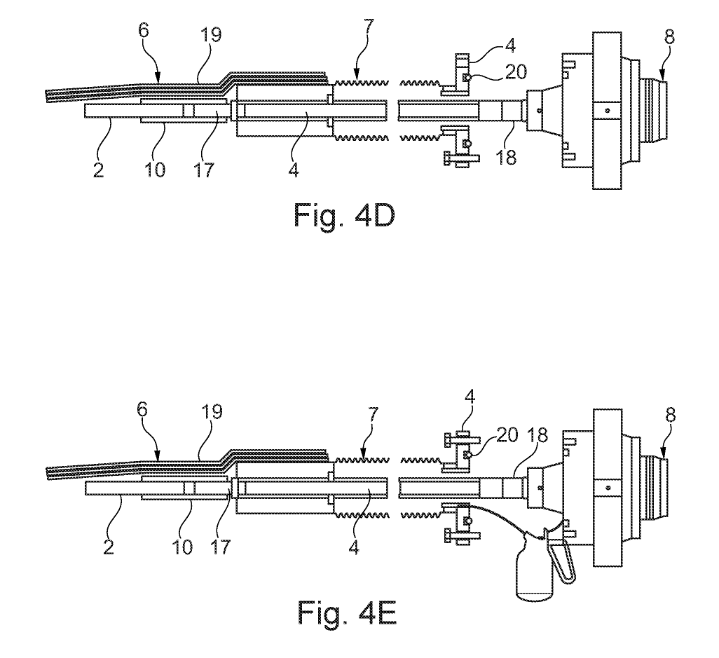

The assembly of the electrical connection 1 proceeds as follows. The electric conductor cable 4 is provided with the attached pin 17 and insulating sleeve 11. The silicon sheath 22 and the second insulating element 2 are then fit onto the cable 4. Also, the crimping sleeve 10 is used to fix the cable 4 to the winding 2, as shown in FIG. 4a.

The further pin 18 is attached, as shown in FIG. 4b.

As shown in FIG. 4c, the first insulating element 6, comprising the multilayer sheath 19, is applied onto the terminal part of the winding 2, the crimping sleeve 10 and at least in part onto the insulating sleeve 11. The multilayer sheath 19 is then impregnated with thermosetting resin. After resin has been set, the whole assembly, together with at least part of the winding 2 is heated in order to hermetically seal the multilayer sheath 19 onto the winding 2, the crimping sleeve 10 and the insulating sleeve 11. According to this solution a mechanical and chemical resistant coating is provide onto part of the assembly, for protecting it from corrosion and mechanical stresses due to the high pressure external ambient.

The electric terminal 8 is connected to the cable 4, as shown in FIG. 4d.

Optionally, if the flexible pipe 12 is used, the space between the flexible pipe 12 itself and the cable 4 is filled with oil, as shown in FIG. 4e.

The flange 14 can then be fixed either to the electric terminal 8 or to the casing 9.

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. Electrical connection assembly for subsea applications, comprising an electrical conductor cable electrically connectable to a winding of an electrical load and electrically connectable to an electrical power source; a first insulating element configured to be placed at least in part over the winding; a second insulating element placed at least in part over the electrical conductor cable; wherein the first insulating element partially overlaps the second insulating element, the first insulating element being sealed onto the second insulating element; and
wherein the second insulating element comprises a covering pipe separated from the conductor cable by means of an insulating sleeve so to define a hermetically sealed space between the covering pipe and the cable.

2. Electrical connection assembly according to claim 1, also comprising an electric terminal connectable to the electrical power source, the electrical conductor cable being electrically connected to the electric terminal.

3. Electrical connection assembly according to claim 1, wherein the second insulating element is connected to the electric terminal

4. Electrical connection assembly according to claim 1, wherein the second insulating element is connectable to a casing of a subsea device containing the electrical connection assembly.

5. Electrical connection assembly according to claim 1, also comprising a crimping sleeve for joining the winding to the electrical conductor cable.

6. Electrical connection assembly according to claim 1, wherein the hermetically sealed space is filled with oil or an inert gas.

7. Electrical connection assembly according to claim 1, wherein the insulating sleeve is made of ceramic.

8. Electrical connection assembly according to claim 1, wherein the first insulating element is attached to the insulating sleeve.

9. Electrical connection assembly according to claim 1, wherein the covering pipe is a flexible pipe attached to the cable by means of the insulating sleeve.

10. Electrical connection assembly according to claim 1, wherein the covering pipe is a rigid tube attached to the cable by means of the insulating sleeve.

11. Electrical connection assembly according to claim 9, wherein the second insulating element comprises a flange sealed onto the electric terminal or sealable onto the casing.

12. Electrical connection assembly according to claim 11, wherein flange is sealed onto flexible pipe or to the rigid tube.
